(19) United States
(12) Patent Application Publication
(10) Pub. No.: US 2007/0147252 A1
(43) Pub. Date: Jun. 28, 2007

(54) METHOD FOR REDUCING TRAFFIC LOADING IN AN AD-HOC NETWORK

(75) Inventor: MICHAEL D. KOTZIN, BUFFALO GROVE, IL (US)

Correspondence Address: MOTOROLA INC, 600 NORTH US HIGHWAY 45, ROOM AS437, LIBERTYVILLE, IL, 60048-5343, US

(73) Assignee: MOTOROLA, INC., LIBERTYVILLE, IL (US)

(21) Appl. No.: 11/614,506

(22) Filed: Dec. 21, 2006

Related U.S. Application Data
(60) Provisional application No. 60/754,131, filed on Dec. 27, 2005.

(51) Int. Cl. H04L 12/26; H04J 1/16

(52) U.S. Cl. 370/235; 370/230

(57) ABSTRACT

Disclosed is a method in a multi-hop network node for reducing data traffic loading comprising the steps of storing (204) a first communication portion, of a plurality of communication portions, received at a network node in a network node memory. Then generating (206) a first communication portion checksum and forwarding (208) the first communication portion to a destination from the network node. The method in the network node also comprises storing (210) the first communication portion checksum in a table of the network node. Then receiving (302) a second communication portion and determining the second communication portion checksum. Then determining (304) that the first communication portion checksum and the second communication portion checksum are the same and determining (310) that at least one more communications portion of the plurality of communication portions, already stored at the network node, is associated with the received first communication portion. The method then comprises sourcing (316) from the network node the at least one more communication portion to the destination.

### FIELD OF THE INVENTION

The present invention relates generally to data transfer methods and, more particularly to reducing data traffic.

### BACKGROUND OF THE INVENTION

In a data network, information is sent from a source to a destination, usually traversing many intermediate nodes of the network. With peer-to-peer data traffic, it is often the case that the same information will be sent through the nodes of the network to many other nodes. This kind of traffic can load the network as well as load the individual nodes that forward the information. When data is sent to or requested by multiple destinations or multiple times by the same destination for example the same data is repeatedly sent through the network. This results in unnecessary network traffic loading as well as node resource loading.

The various aspects, features and advantages of the present invention will become more fully apparent to those having ordinary skill in the art upon careful consideration of the following Detailed Description of the Invention with the accompanying drawings described below.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is an exemplary network block diagram.

FIG. 2 is an exemplary process flow diagram for reducing data traffic loading.

FIG. 3 is an exemplary process flow diagram for reducing data traffic loading.

FIG. 4 is an exemplary communication portion table.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF THE DRAWINGS

While the present invention is achievable by various forms of embodiment, there is shown in the drawings and described hereinafter several examples of embodiments with the understanding that the present disclosure is to be considered an exemplification of the invention and is not intended to limit the invention to the specific embodiments contained herein as will become more fully apparent from the discussion below. It is further understood that the traffic loading reduction method of the present invention may be used more generally in any application where it is desirable to reduce data congestion.

This disclosure proposes that network nodes retain information received and forwarded, i.e. communication portions that flow through the node from a source to a destination. The information is cataloged in a list or table stored at the node. In one exemplary embodiment the communication portions are made up of data packets. A communication portion may be made up of one data packet or alternatively a plurality of data packets. Each communication portion is part of a plurality of communication portions which form a larger data file such as a motion picture or a song or other large file or the like. In one embodiment, each communication portion is identified by its checksum and the checksum of the next communication portion. When a node gets a new communication portion to forward, it checks its memory to determine if the same communication portion has been carried by the node and has been saved in the node's memory. If it finds the same communication portion already stored in the nodes memory, it first determines how many additional communication portions of the plurality of communication portions it has in its memory that it can source in place of the originating source. It does this using the linkage to the next packet checksum in the table.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element. The terms “a” or “an” may mean more than one.

It will be appreciated that embodiments of the invention described herein may be comprised of one or more conventional processors and unique stored program instructions that control the one or more processors to implement, in conjunction with certain non-processor circuits, some, most, or all of the functions of initiating a packet data transmission in the network described herein. The non-processor circuits may include, but are not limited to, a receiver, a transmitter, signal drivers, clock circuits, power source circuits, and logic circuits.

Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

Before describing in detail exemplary embodiments that are in accordance with the present invention, it should be observed that the embodiments reside primarily in combinations of components related to data transfer in networks having at least one node. Accordingly, the apparatus components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

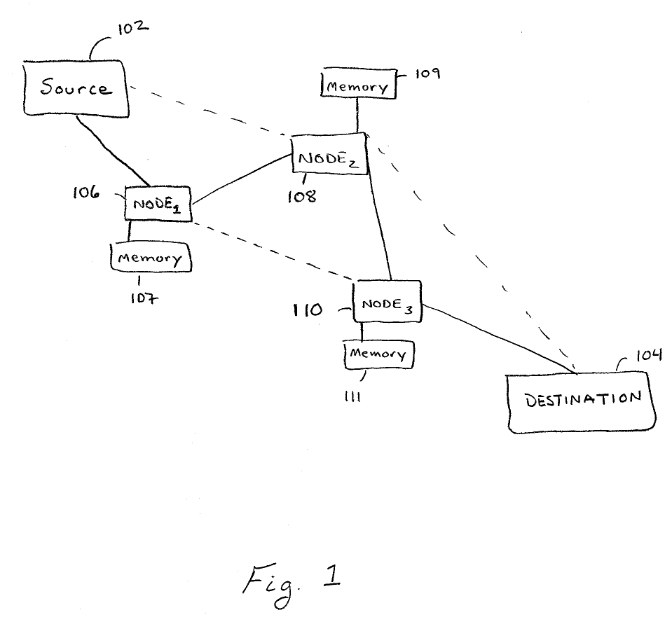

FIG. 1 illustrates an exemplary network including a data source 102, a destination 104, and a plurality of network nodes: a first network node 106, a second network node 108 and a third network node 110. In this exemplary embodiment, the source 102 is coupled to the first node 106 which is coupled to the second node 108 which is coupled to the third node 110 which is coupled to the destination 104. Although three nodes are shown, it is to be understood that the number of network nodes is merely exemplary as the network may include one node or it may include a plurality of nodes. The first network node includes a first memory 107, the second network node includes a second memory 109 and the third network node includes a third memory 111.

In addition to the variable number of nodes, the connections of the network may also vary. For example, the plurality of nodes may be coupled as illustrated by the dotted lines in one exemplary embodiment. It is also understood that the connections may also change over time and even on a regular basis regardless of whether or not the same nodes make up the network. For example in an mobile ad-hoc network, the devices making up the network constantly change as new devices move in and out of range or turn on and off or other like operations common in ad-hoc networks. It is also understood that a node may be a source and the source may not necessarily be the originating source of the data.

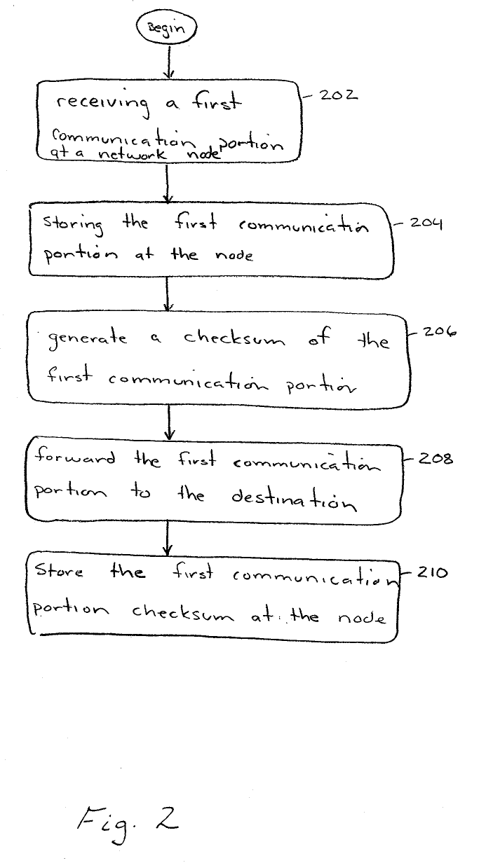

In FIG. 2, an exemplary flow diagram is shown illustrating the method for reducing data traffic in a network comprising receiving 202 at a network node, a first communication portion of a first plurality of communication portions to be forwarded to a destination 104. The network node stores 204 the first communication portion in a memory of the network node and generates 206 a first communication portion checksum of the first communication portion. Then the network node forwards 208 the first communication portion to the destination. The network node stores 210 the first communication portion checksum of the first communication portion in a table in a memory of the network node. As the other communication portions of the first plurality of communication portions (i.e. the second communication portion the third communication portion and so on, all of the first plurality of communication portions) are received at the first network node 106, each communication portion and each communication portion checksum is stored at the node as described above.

The first plurality of communication portions may be a data file of finite size or streaming data that may or may not have a finite size. In one exemplary embodiment wherein the first plurality of communication portions form one large data file that is divided up into data packets, all of the communication portions of the one large file may pass through the same first network node 106 for example. In another exemplary embodiment not all of the communication portions of the plurality of communication portions pass through the first network node 106 and only a certain number of them do for example. Regardless of whether all or some of the communication portions are stored at the first network node 106, the first network node 106 will have the capability of sourcing to the destination 104 the communication portions stored therein in place of the source 102.

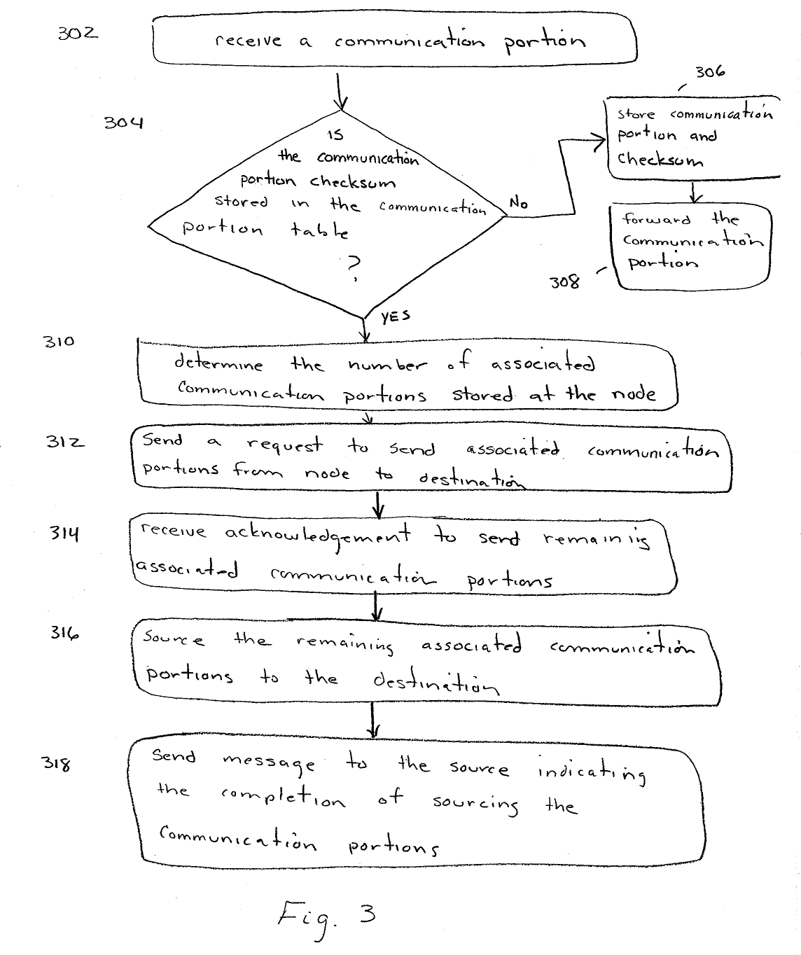

Continuing, the method further comprises, as illustrated in the exemplary flow diagram shown in FIG. 3, receiving 302 a second communication portion of a second plurality of communication portions at the first network node 106 subsequent to receiving the first communication portion of the first plurality of communication portions. The first plurality of communication portions and the second plurality of communication portions are sent through (stored and forwarded) the network and in particular the first network node 106 at different times. To reduce the traffic loading on the network, once the node 106 determines that it can source the remaining communication portions, the source ceases to send communication portions to the node 106. For example, a first user may request song “A” from the source 102. The source 102 transmits through the network and in particular through the first network node 106, song “A” which is formed by a first plurality of data packets. Each packet and each packet checksum is stored at the first network node 106 as described in FIG. 2. When a second user requests the same song “A”, the packets of a second plurality of data packets forming the song “A” are sent to the second user and begin to pass through the first network node 106. The first network node 106 determines that the checksum of the first data packet of the second plurality of data packets is the same as the first data packet of the first plurality of data packets. The remaining data packets, the data packets from the first plurality of data packets stored at the first network node 106 are then sourced from the node 106 thereby sending song “A” to the second user.

Returning to FIG. 3, in this exemplary embodiment, the first plurality of communication portions is sent at a first time and the second plurality of communication portions is sent at a time after the first communication portions are sent. Then, the method comprises, determining 304 whether the first communication portion checksum and the second communication portion checksum are the same. If they are not the same, then the second communication portion and the second communication portion checksum are stored 306 in the table of the node. Then, the second communication portion is forwarded as discussed in reference to FIG. 2.

If the network node 106 determines that the second communication portion checksum is stored in the table, then the node 106 determines 310 whether there are associated communication portions stored in a memory of the node 106 and if so, the number of additional communication portions present. In one exemplary embodiment, the stored communication portion table includes the first communication portion checksum and the next or second communication portion checksum. The next communication portion to be sourced to the destination 104 is identified by the next checksum stored in the table. In one exemplary embodiment the network node 106 immediately begins sourcing the remaining communication portions.

Alternatively, in another exemplary embodiment, the first network node 106 sends 312 a request to the source 102, requesting permission for the first network node 106 to source the remaining communication portions stored at the network node 106, therefrom. The node 106 will then receive 314 an acknowledgement to send at least some of the remaining communication portions to the destination 104 in place of the source 102. The source will cease or terminate sending the communication portions now being sourced from the first network node 106 reducing traffic loading in the network.

Alternatively, the network nodes may report back to the source that the network node has encountered the same communication portions and related communication portions at the node and that node is capable of sourcing at least some of the remaining communication portions or that the source should query the node to determine if it is capable of sourcing the remaining communication portions.

Once the network node 106 completes sending the remaining communication portions (which may not be the entire communication being sent) the network node 106 sends 316 a message to the source indicating that the transmission of the remaining communication portions available at the node 106 has been completed by the node 106. It may also indicate which communication portions of the communication were sent.

The checksums may be used to identify communication portions. For example, the node may receive a communication portion with the checksum of the next communication portion. This would be a certain indication to an intermediate node that in fact, it does have exactly the right packet to forward. In one exemplary embodiment, when a match is detected, the node may check with the source what the next checksums are of the packets that would be forwarded. Sending only the checksums between the intermediary node and the source is favorable as the amount of data in a checksum in general will be much less then the data packet or packets of the communication portion thereby minimizing data traffic loading.

The first portion is not necessarily the first logical portion of the entire piece of information being sent to the source. The communication portions of the plurality of communication portion are linked by the communication portion table stored at the node 106 however they may not be stored in logical order.

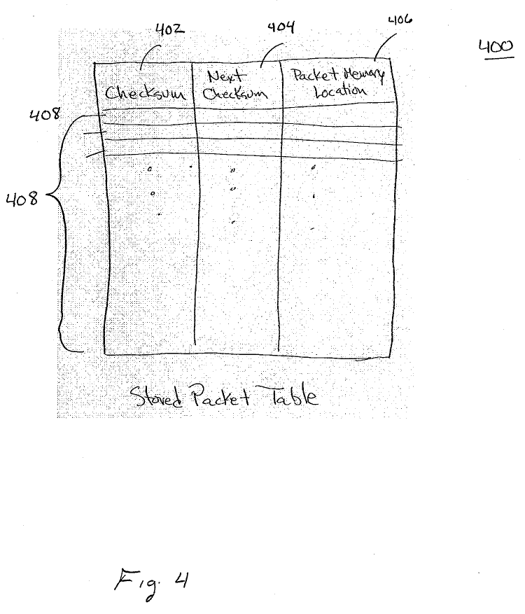

FIG. 4 illustrates an exemplary stored communication portion table 400. The table includes a column for the checksum 402 and the next communication portion checksum 404 and the location of the communication portion for the check sum 406. When the node determines that the first communication portion checksum and the second communication portion checksum are the same, the table will indicate to the node the next checksum that is linked to or associated with the first communication portion checksum. The node iteratively may then determine all of the communication portions stored at the node that are liked to the first communication portion and consequently linked to the second communication portion sent as part of the second plurality of communication portions. It is also understood that there may be alternative methods for linking the communication portions stored in the table or similar database at network nodes. Each communication portion received will have an entry in the table 408.

Returning to FIG. 1, in one exemplary embodiment the first network node 106 would receive the first plurality of communication portions before the second node 108 and the third node 110. Each node along the way to the destination however may also store the first plurality of communication portions. A second destination, not shown, for example may then couple to the third node and upon requesting the plurality of communication portions from the source 102, receive the remaining communicating portions from the third node 110. Now, it is not necessary to transmit the remaining communication portions between the source 102 and the first node 106 through to the second node and through to the third node, reducing data traffic loading in the network.

Further, it is to be understood that the source 104 may be another node or the originator of the communication. For example, in FIG. 1 the source 104 may be an intermediate node receiving information from another node or source. In another exemplary embodiment, the first network node 106 is the source and the second network node 108 is the intermediate node.

The network node is intermediary to a source, which may be the data originator or another intermediary node, and destination, which also may be another intermediary node, for exchanging communication portions comprises a network connection to the source and the destination. The network connection may be any type of network connection including an ad-hoc connection, a peer to peer connection, a master slave connection such as USB, a wireless connection or the like. A processor coupled to the network connection and a memory coupled to the processor.

The node further comprises, a sourcing management module, which may be hardware or software and further may be auxiliary to the network node or incorporated therein, for determining that the checksum of a first communication portion received at the intermediary node is the same as the checksum of a stored communication portion stored in the memory of the intermediary node. The sourcing management module also determines that at least some related communication portions, related to the first communication portion, are stored in the memory and the management module sourcing may determine the sourcing the at least some related communication portions to a destination.

The node still further comprises a first in first out memory management module to management a plurality of stored communication portions in the memory of the node.

A network source for sending data to a destination comprises a network connection to an intermediary network node, a processor coupled to the network connection, and a memory of the network source for storing data to be sourced from the network source. The network source further comprises a sourcing management module for receiving a message from an intermediary network node that the intermediary network node can source at least some of the communication portions that were originally scheduled to be sent by the network source. And the sourcing management module id for sending a message to the intermediary network node indicating to the node to send the at least some of the communication portions to the destination. In one exemplary embodiment the network source is an intermediary network node.

While the present inventions and what is considered presently to be the best modes thereof have been described in a manner that establishes possession thereof by the inventor and that enables those of ordinary skill in the art to make and use the inventions, it will be understood and appreciated that there are many equivalents to the exemplary embodiments disclosed herein and that myriad modifications and variations may be made thereto without departing from the scope and spirit of the inventions, which are to be limited not by the exemplary embodiments but by the appended claims.

What is claimed is:

1. A method in a multi-hop network node for reducing data traffic loading comprising:
storing a first communication portion, of a plurality of communication portions, received at a network node in a network node memory;
generating a first communication portion checksum;
forwarding the first communication portion to a destination from the network node;
storing the first communication portion checksum in a table of the network node;
receiving a second communication portion;
determining the second communication portion checksum;
determining that the first communication portion checksum and the second communication portion checksum are the same;
determining that at least one more communications portion of the plurality of communication portions, already stored at the network node, is associated with the received first communication portion; and
sourcing from the network node the at least one more communication portion to the destination.

2. The method of claim 1, receiving a plurality of communication portions associated with the first communication portion;
storing the plurality of communication portions in the memory of the network node; and
storing each communication portion checksum of the plurality of communication portions received.

3. The method of claim 2, linking the plurality of communication portions associated with the first communication portion by each communication portion checksum.

4. The method of claim 2, sourcing the at least one more communicating portion by sending a message to the source of the plurality of communication portions, indicating that at least some of the remaining communication portions received at the network node will be sourced from the network node to the destination.

5. The method of claim 2, sourcing the at least one more communicating portion by requesting permission from the source of the plurality of communication portions to send the at least one more communication portion of the plurality of communication portions received at the network node.

6. The method of claim 5, receiving an acknowledgment from the source to send the at least some of the remaining plurality of communication portions to the destination.

7. The method of claim 5, sending at least some of the remaining communication portions of the plurality of communication portions.

8. The method of claim 7, receiving a command from the source to stop sending the plurality of communication portions.

9. The method of claim 1, identifying in the table each communication portion by its checksum and the checksum of the next data packet.

10. A method for data transfer comprising:
receiving a first data packet of a plurality of data packets;
determining the checksum of the first data packet;
determining that a first data packet checksum is in a checksum table;
determining the number of data packets present at the node that are associated with the first data packet; and
sending from a memory of the intermediate node at least some of the remaining data packets of the plurality of data packets to the destination.

11. The method of claim 10, requesting permission from source of the first data packet to send associated data packets of the plurality of data packets.

12. The method of claim 11, receiving message acknowledging permission to send at least some of the remaining data packets to the destination

13. The method of claim 10, sending message to source alerting source that the node will send the at least some of the remaining associated data packets to the destination.

14. The method of claim 13, sending message to source indication completion of sending the associated packets to the destination.

15. A method for reducing ad hoc network congestion comprising:
sending a first data packet, which is one data packet of a plurality of associated data packets, from a first source to a first node in route to a destination;
determining at the first node that the first data packet has been previously stored in a memory coupled to the first node;
sending a message to the first source that the first data packet and at least a portion of the plurality of associated data packets are stored in the memory of the first node; and
sourcing the first data packet and the at least a portion of a plurality of associated data packets from the first node to the destination.

16. A method for reducing network congestion comprising:
receiving, in response to sending a first data packet that is associated with a plurality of data packets, a message from a first intermediate network node indicating that the intermediate network node can source at least a portion of the plurality of data packets;
sending an acknowledgement to the intermediate network node granting permission to source the at least a portion of a plurality of data packets to the destination; and
terminating the transmission of the remaining data packets of the plurality of data packets.

17. The method of claim 16, receiving a message indicating that there is a second intermediate network node available to source the plurality of data packets.

18. The method of claim 17, sending a message to the first intermediate network node to stop sending the at least a portion of a plurality of data packets; and
sending a message to the second intermediate network node to begin sending the at least a portion of a plurality of data packets.

19. The method of claim 16, receiving a second message from a second intermediate network node indicating that the second intermediate network node can source at least a portion of the plurality of data packets; and
sending an acknowledgement to the second intermediate network node granting permission to source the at least a portion of a plurality of data packets to the destination.

20. The method of claim 19, sending a message to the first intermediate network node to terminate transmission of the at least a portion of a plurality of data packets.

21. A network node intermediary to a source and destination for exchanging communication portions comprising:
a network connection to a source and a destination;
a processor coupled to the network connection;
a memory coupled to the processor; and
a sourcing management module for determining that the checksum of a first communication portion received at the intermediary node is the same as the checksum of a stored communication portion stored in the memory of the intermediary node and for determining that at least some related communication portions, related to the first communication portion, are stored in the memory and for sourcing the at least some related communication portions to a destination.

22. The network node of claim 21, wherein the network connection is wireless network connection.

23. The network node of claim 21, further comprising a first in first out memory management module to management a plurality of stored communication portions in the memory of the node.

24. A network source for sending data to a destination comprising:
a network connection to an intermediary network node;
a processor coupled to the network connection;
a memory of the network source for storing data to be sourced from the network source; and
a sourcing management module for receiving a message from an intermediary network node that the intermediary network node can source at least some of the communication portions to be sent by the network source, and sending a message to the intermediary network node indicating to the node to send the at least some of the communication portions to the destination.

25. The network source of claim 25, wherein the network source is an intermediary network node.
